(19) United States
(12) Patent Application Publication
(10) Pub. No.: US 2023/0180116 A1
(43) Pub. Date: Jun. 8, 2023

(54) METHOD AND APPARATUS FOR INFORMATION SYNCHRONIZATION

(71) Applicant: Telefonaktiebolaget LM Ericsson (publ), Stockholm (SE)

(72) Inventors: Chunbo WANG, SHANGHAI (CN); Daniel NILSSON, ÄLVÄNGEN (SE); Cheng WANG, SHANGHAI (CN); Ralf KELLER, WÜRSELEN (DE)

(21) Appl. No.: 17/920,321

(22) PCT Filed: Apr. 30, 2020
(86) PCT No.: PCT/CN2020/088400

§ 371 Date: Oct. 20, 2022

(51) Int. Cl. H04W 48/18; H04W 36/00; H04L 9/40

(52) U.S. Cl. CPC H04W 48/18; H04W 36/0033; H04L 63/0892; H04W 88/16

(57) ABSTRACT

Embodiments of the present disclosure provide methods and apparatus for information synchronization. A method at a data management node comprises receiving a first message including an identity of a first gateway from the first gateway. The first gateway serves a session of a terminal device. The terminal device accesses to a network from a second gateway. The method further comprises sending a second message including the identity of the first gateway to an authentication, authorization, and accounting (AAA) server. The first message further includes a first indication that the terminal device accesses to the network from the second gateway.

### TECHNICAL FIELD

The non-limiting and exemplary embodiments of the present disclosure generally relate to the technical field of communications, and specifically to methods and apparatuses for information synchronization.

### BACKGROUND

This section introduces aspects that may facilitate a better understanding of the disclosure. Accordingly, the statements of this section are to be read in this light and are not to be understood as admissions about what is in the prior art or what is not in the prior art.

3GPP (3rd Generation Partnership Project) EPS (evolved packet system) Core Network supports connectivity of UEs through non-3GPP IP (Internet protocol) access networks (e.g. WLAN (Wireless Local Area Network)) via evolved packet data gateway (ePDG) integrated Evolved Packet Core (EPC). 3GPP also defines interworking between ePDG connected to EPC and 5GS (fifth generation system).

To support smooth handover between 3GPP access and Non-3GPP access and IP address preservation for user equipment (UE), the address information of a combined session management function plus packet data network gateway control plane (SMF+PGW-C) entity is shared and/or synchronized between EPC and 5GC (fifth generation Core Network) via HSS (Home Subscriber Server)/UDM (unified data management), thus the serving nodes (e.g. ePDG/AAA (authentication, authorization, and accounting), AMF (Access and Mobility Management Function)) can read from HSS/UDM and select the same combined SMF+PGW-C if conditions allow, e.g. UE terminal supporting the functionality, UE subscription supporting, combined SMF+PGW-C available, etc.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In 3GPP TS 23.501 V16.4.0, the disclosure of which is incorporated by reference herein in its entirety, an enhancement of ePDG/EPC and 5GS interworking (i.e., the use of N10 interface instead of S6b) is introduced to make S6b interface optional between SMF+PGW-C and 3GPP AAA server. However, there are some problems with the use of N10 interface instead of S6b. For example, notification of PGW-C assignment from HSS to the 3GPP AAA server, as defined in 3GPP TS 23.402 V16.0.0, would trigger the 3GPP AAA server to update the ePDG with the new PGW identity data via SWm interface request procedure. However, in this case, it is the ePDG selecting SMF+PGW-C, hence the notification of PGW-C assignment towards ePDG is superfluous and may lead to wrong interpretation and handling in ePDG, such as release of existing established PDN connection and setup a new PDN connection over the SMF+PGW-C as indicated in the notification of PGW-C assignment message.

To overcome or mitigate the above mentioned problem or other problem(s), the embodiments of the present disclosure propose an improved information synchronization solution.

In a first aspect of the disclosure, there is provided a method at a data management node. The method comprises receiving a first message including an identity of a first gateway from the first gateway. The first gateway serves a session of a terminal device. The terminal device accesses to a network from a second gateway. The method further comprises sending a second message including the identity of the first gateway to an authentication, authorization, and accounting (AAA) server.

In an embodiment, the first message may further include a first indication that the terminal device accesses to the network from the second gateway.

In an embodiment, the second message may further include a second indication for indicating the AAA server to suppress a request towards the second gateway.

In an embodiment, the request may be a re-authorization request.

In an embodiment, the second message may further include a second indication for indicating that the terminal device accesses to the network from the second gateway.

In an embodiment, the method may further comprise storing the identity of the first gateway.

In an embodiment, the identity of the first gateway may be a fully qualified domain name (FQDN) or an Internet protocol (IP) address.

In an embodiment, the data management node may be a combined home subscriber server plus unified data management (HSS+UDM) entity.

In an embodiment, the first gateway may be a combined session management function plus packet data network gateway control plane (SMF+PGW-C) entity.

In an embodiment, the second gateway may be an evolved packet data gateway (ePDG).

In an embodiment, the first message may be an Nudm_UECM_Registration Request.

In an embodiment, the second message may be a Push-Profile-Request message.

In a second aspect of the disclosure, there is provided a method at an authentication, authorization, and accounting (AAA) server. The method comprises receiving a message including an identity of a first gateway serving a session of a terminal device from a data management node. The method further comprises suppressing a request towards a second gateway based on the message. The terminal device accesses to a network from the second gateway.

In an embodiment, the request may be a re-authorization request.

In an embodiment, the message further may include an indication for indicating the AAA server to suppress the request towards the second gateway.

In an embodiment, the message may further include an indication for indicating that the terminal device accesses to the network from the second gateway.

In an embodiment, the method may further comprise storing the identity of the first gateway.

In an embodiment, the message may be a Push-Profile-Request message.

In a third aspect of the disclosure, there is provided a data management node. The data management node comprises a processor; and a memory coupled to the processor, said memory containing instructions executable by said processor, whereby said data management node is operative to receive a first message including an identity of a first gateway from the first gateway. The first gateway serves a session of a terminal device. The terminal device accesses to a network from a second gateway. Said data management node is further operative to send a second message including the identity of the first gateway to an authentication, authorization, and accounting (AAA) server. The first message further includes a first indication that the terminal device accesses to the network from the second gateway

In a fourth aspect of the disclosure, there is provided an authentication, authorization, and accounting (AAA) server. The AAA server comprises a processor; and a memory coupled to the processor, said memory containing instructions executable by said processor, whereby said AAA server is operative to receive a message including an identity of a first gateway serving a session of a terminal device from a data management node. Said AAA server is further operative to suppress a request towards a second gateway based on the message. The terminal device accesses to a network from the second gateway.

In a fifth aspect of the disclosure, there is provided a data management node. The data management node comprises a receiving module and a sending module. The receiving module may be configured to receive a first message including an identity of a first gateway from the first gateway. The first gateway serves a session of a terminal device. The terminal device accesses to a network from a second gateway. The sending module may be configured to send a second message including the identity of the first gateway to an authentication, authorization, and accounting (AAA) server. The first message further includes a first indication that the terminal device accesses to the network from the second gateway

In an embodiment, the data management node may further comprises a storing module configured to store the identity of the first gateway.

In a sixth aspect of the disclosure, there is provided an AAA server. The AAA server comprises a receiving module and a suppressing module. The receiving module may be configured to receive a message including an identity of a first gateway serving a session of a terminal device from a data management node. The suppressing module may be configured to suppress a request towards a second gateway based on the message. The terminal device accesses to a network from the second gateway.

In an embodiment, the AAA server may further comprises a storing module configured to store the identity of the first gateway.

In a seventh aspect of the disclosure, there is provided a computer program product comprising instructions which, when executed on at least one processor, cause the at least one processor to carry out the method according to any of the first and second aspects of the disclosure.

In an eighth aspect of the disclosure, there is provided a computer-readable storage medium storing instructions which, when executed on at least one processor, cause the at least one processor to carry out the method according to any of the first and second aspects of the disclosure.

Embodiments herein afford many advantages, of which a non-exhaustive list of examples follows. In some embodiments herein, the proposed solution can ensure correct PGW assignment information available in 3GPP AAA server if PGW-C+SMF is selected for UEs establishing PDN connection from ePDG and N10 interface is used to report PGW assignment information to HSS/UDM. Therefore, in later handover, the 3GPP AAA server can provide the proper information of PGW to ePDG. In some embodiments herein, the proposed solution can ensure a proper indication is provided to the 3GPP AAA server hence it can suppress request procedure towards ePDG to avoid mis-interpretation/mis-handling in ePDG. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 schematically shows a non-roaming architecture for interworking between ePDG/EPC and 5GS according to an embodiment of the present disclosure;

FIG. 2 schematically shows a local breakout roaming architecture for interworking between ePDG/EPC and 5GS according to an embodiment of the present disclosure;

FIG. 3 schematically shows a home-routed roaming architecture for interworking between ePDG/EPC and 5GS according to an embodiment of the present disclosure;

FIG. 4 shows a flowchart of a method according to an embodiment of the present disclosure;

FIG. 5 shows a flowchart of a method according to another embodiment of the present disclosure;

FIG. 6 shows a flowchart of a method according to another embodiment of the present disclosure;

FIG. 7a illustrates a simplified block diagram of an apparatus that may be embodied in/as a data management node according to an embodiment of the present disclosure;

FIG. 7b illustrates a simplified block diagram of an apparatus that may be embodied in/as an AAA server according to an embodiment of the present disclosure;

FIG. 8 is a block diagram showing a data management node according to an embodiment of the disclosure; and

FIG. 9 is a block diagram showing an AAA server according to an embodiment of the disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable wireless/wired communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by some of standards organizations such as 3GPP (3rd Generation Partnership Project). For example, the communication protocols as defined by 3GPP may comprise the third generation (3G), fourth generation (4G), 4.5G, the fourth generation (5G) communication protocols, and/or any other protocols either currently known or to be developed in the future.

The term “network node” used herein refers to a network device or entity such as a core network device in a communication network. For example, in a wireless communication network such as a 3GPP-type cellular network, the network node may be a core network device, which may offer numerous services to customers who are interconnected by an access network device. Each access network device is connectable to the core network device over a wired or wireless connection.

The term “network function (NF)” refers to any suitable function which can be implemented in a network entity (physical or virtual) of a communication network. For example, the 5G system (5GS) may comprise a plurality of NFs such as AMF (Access and Mobility Management Function), SMF (Session Management Function), AUSF (Authentication Service Function), UDM (Unified Data Management), PCF (Policy Control Function), AF (Application Function), NEF (Network Exposure Function), UPF (User plane Function) and NRF (Network Repository Function), RAN (radio access network), SCP (service communication proxy), NWDAF (network data analytics function), etc. In other embodiments, the network function may comprise different types of NFs for example depending on the specific network. The 4G system may comprise a plurality of network entities such as mobility management entity (MME) SGW (serving gateway), PGW (packet data network (PDN) gateway), PCRF (Policy and Charging Rules Function), 3GPP AAA server, HSS, ePDG, eNB, etc. An architecture of control and user plane separation (CUPS) of various network devices such as SGW, PGW, etc. has been introduced in a communication network. In the architecture of CUPS, various interfaces between the control plane nodes (or functions) and the user plane nodes (or functions) have been defined. For example, an Sxb interface is defined between a PGW control plane (PGW-C) and a PGW user plane (PGW-U) and an Sxa interface is defined between a SGW control plane (SGW-C) and a SGW user plane (SGW-U). An N4 interface is defined between a Session Management Function (SMF) and a User Plane Function (UPF). In some embodiments, the network entity or function with same or similar functions in different networks can be referred to as a combined network entity, for example, PGW-C+SMF, PGW-U+UPF, PCF+PCRF, etc.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP' LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment”, “an embodiment”, “an example embodiment”, and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” should be understood to mean “only A, only B, or both A and B.” The phrase “A and/or B” should be understood to mean “only A, only B, or both A and B.”

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for ease of description and differentiation among nodes, devices or networks, etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

It is noted that some embodiments of the present disclosure are mainly described in relation to the cellular network as defined by 3GPP being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

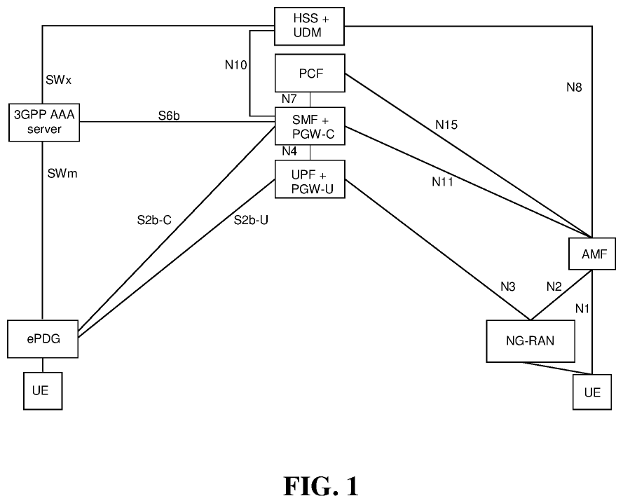

Although the subject matter described herein may be implemented in any appropriate type of system using any suitable components, the embodiments disclosed herein are described in relation to a communication system complied with the exemplary system architectures illustrated in FIGS. 1-3. For simplicity, the system architectures of FIGS. 1-3 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

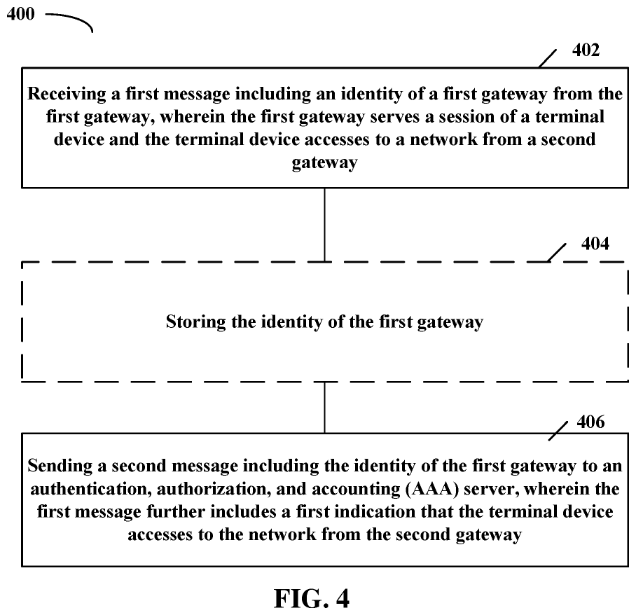

FIG. 1 schematically shows a non-roaming architecture for interworking between ePDG/EPC and 5GS according to an embodiment of the present disclosure. The system architecture of FIG. 1 is same as the architecture as FIG. 4.3.4.1-1 of 3GPP TS 23.501 V16.4.0, and may comprise some exemplary network nodes such as UE, ePDG, 3GPP AAA server, UPF+PGW-U, SMF+PGW-C, PCF, HSS+UDM, AMF, NG-RAN (next generation-RAN). As further illustrated in FIG. 1, the exemplary system architecture also contains some interfaces such as S2b-C, S2b-U, SWm, SWx, S6b, N10, N7, N4, N1, N2, N3, N8, N11 and N15, etc. Various network nodes shown in FIG. 1 may be responsible for functions for example as defined in various 3GPP specifications such as 3GPP TS 23.501 V16.4.0 and 3GPP TS 23.401 V16.6.0, the disclosure of which is incorporated by reference herein in its entirety.

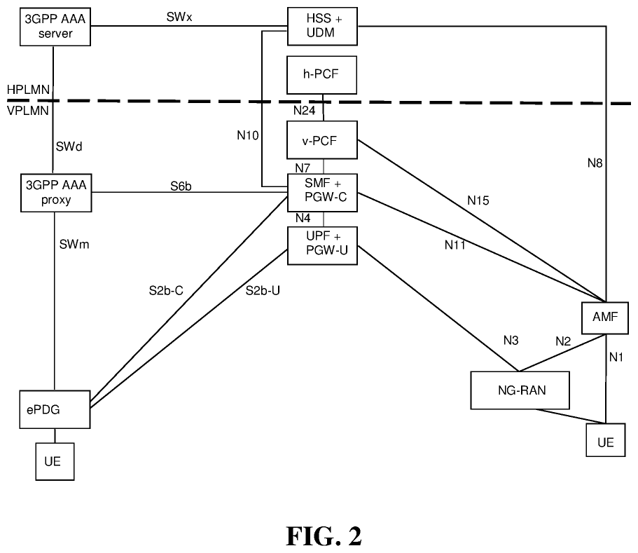

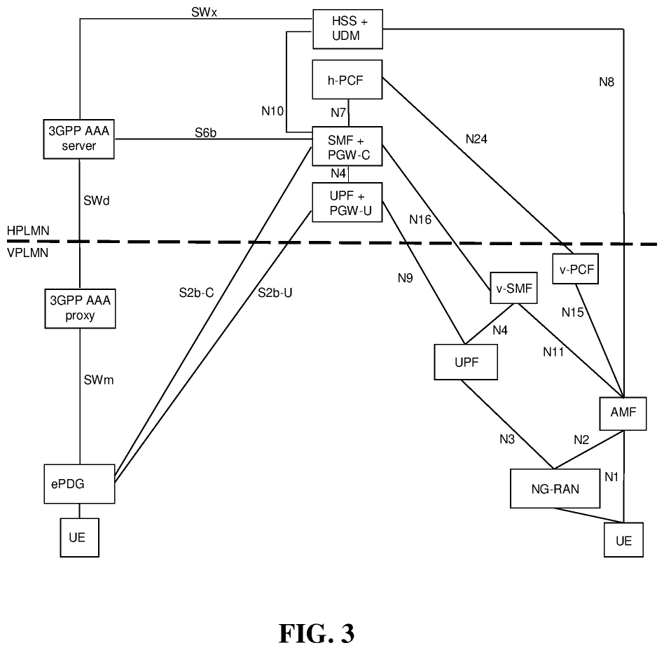

FIG. 2 schematically shows a local breakout roaming architecture for interworking between ePDG/EPC and 5GS according to an embodiment of the present disclosure. FIG. 3 schematically shows a home-routed roaming architecture for interworking between ePDG/EPC and 5GS according to an embodiment of the present disclosure. The system architecture of FIG. 2 is same as the architecture of FIG. 4.3.4.2-1 of 3GPP TS 23.501 V16.4.0. The system architecture of FIG. 3 is same as the architecture of FIG. 4.3.4.2-2 of 3GPP TS 23.501 V16.4.0.

The system architecture of FIG. 2 may comprise some exemplary network nodes such as UE, ePDG, 3GPP AAA proxy, 3GPP AAA server, UPF+PGW-U, SMF+PGW-C, h-PCF (home PCF), v-PCF(visited PCF), HSS+UDM, AMF, NG-RAN. As further illustrated in FIG. 2, the exemplary system architecture also contains some interfaces such as S2b-C, S2b-U, SWm, SWx, SWd, S6b, N10, N24, N7, N4, N1, N2, N3, N8, N11 and N15, etc. Various network nodes shown in FIG. 2 may be responsible for functions for example as defined in various 3GPP specifications such as 3GPP TS 23.501 V16.4.0 and 3GPP TS 23.401 V16.6.0, the disclosure of which is incorporated by reference herein in its entirety. HPLMN denotes Home Public Land Mobile Network. VPLMN denotes Visited Public Land Mobile Network.

The system architecture of FIG. 3 may comprise some exemplary network nodes such as UE, ePDG, 3GPP AAA proxy, 3GPP AAA server, UPF+PGW-U, SMF+PGW-C, h-PCF (home PCF), HSS+UDM, v-PCF (visited PCF), v-SMF (visited SMF), UPF, AMF, NG-RAN. As further illustrated in FIG. 3, the exemplary system architecture also contains some interfaces such as S2b-C, S2b-U, SWm, SWx, SWd, S6b, N10, N7, N4, N1, N2, N3, N4, N8, N9, N16, N24, N11 and N15, etc. Various network nodes shown in FIG. 3 may be responsible for functions for example as defined in various 3GPP specifications such as 3GPP TS 23.501 V16.4.0 and 3GPP TS 23.401 V16.6.0, the disclosure of which is incorporated by reference herein in its entirety.

The details of the interfaces between the UE and the ePDG, and between EPC nodes (i.e. SWm, SWd, SWx, S2b and S6b), are documented in 3GPP TS 23.402 V16.0.0.

Interworking with ePDG is only supported with GTP (GPRS (General Packet Radio Service) Tunneling Protocol) based S2b. S6b interface is optional.

The PGW (packet data network gateway) assignment information for non-3GPP access may be reported by the selected SMF+PGW-C to the 3GPP AAA server via S6b interface, where the 3GPP AAA server further reports this information to HSS/UDM via Swx interface. Therefore HSS/UDM can hold and store the PGW assignment information.

In 3GPP TS 23.501 V16.4.0, an enhancement of ePDG/EPC and 5GS interworking is introduced to make S6b interface optional between SMF+PGW-C and 3GPP AAA server. N10 interface of the SMF+PGW-C can instead provide the functionality previously required of S6b, e.g. registration and de-registration of PGW-C address in the HSS/UDM via Nudm_UECM_registration service operation of N10 interface. This feature may allow the removal or avoidance of diameter based S6b interface on SMF+PGW-C when preparing rollout of 5GC core network.

Regarding synchronization of the address information of SMF+PGW-C based on this optional feature, 3GPP TS 23.502 V16.4.0 (the disclosure of which is incorporated by reference herein in its entirety) further defines an “indication that access is from ePDG” (aka “ePDG access indication”) allowing HSS/UDM to synchronize the SMF+PGW-C information but to not further impact the legacy 3GPP AAA/ePDG.

As described in clause 4.11.4.3.6 of 3GPP TS 23.502 V16.4.0, this clause applies to scenarios when ePDG is connected to SMF+PGW-C and S6b in not used. It is applicable for procedures as specified in 3GPP TS 23.402 V16.0.0 (the disclosure of which is incorporated by reference herein in its entirety) including mobility between EPC/ePDG and EPC/EUTRAN (Evolved Universal Terrestrial Radio Access Network) and also for mobility between EPC/ePDG and 5GS.

When S6b as specified in 3GPP TS 23.402 V16.0.0 is not deployed between PGW-C+SMF and the 3GPP AAA server and the UE creates and deletes a PDN connection via ePDG connected to SMF+PGW-C, the registration and de-registration of PDN GW is performed on the N10 interface instead of the S6b interface.

If PGW-C+SMF is selected for the UE that does not support 5GC NAS(Non-Access Stratum), the PGW-C+SMF determines the PDU (Protocol Data Unit) Session ID (identifier) and S-NSSAI (Single Network Slice Selection Assistance Information) in the same way as for PDN connection via EPC/EUTRAN as specified in clause 4.11.0a.5 of 3GPP TS 23.402 V16.0.0.

For roaming scenario with local-breakout (as described in FIG. 4.3.4.2.1 of 3GPP TS 23.501 V16.4.0), the use of N10 interface instead of S6b interface may be based on support of this feature from HSS+UDM to SMF+PGW-C on N10 interface.

The specific impacts to procedures in clauses 7 and 8 of 3GPP TS 23.402 V16.0.0 are as follows:

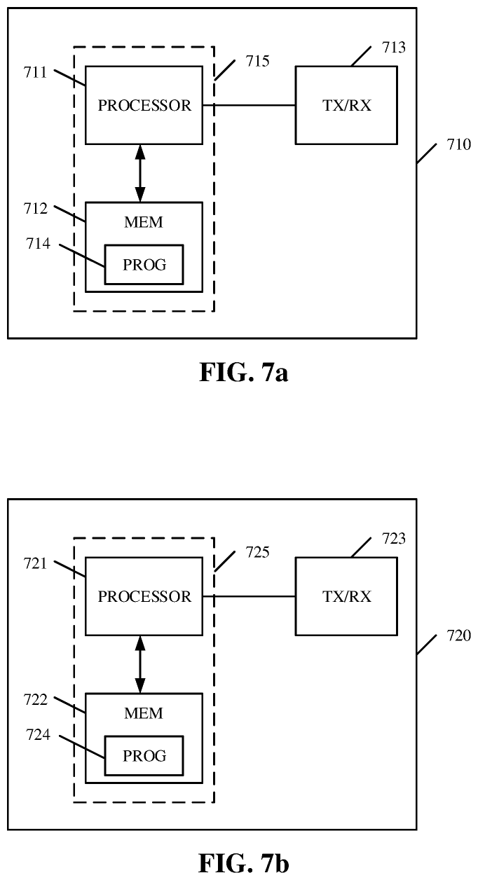

7.2.4 Initial Attach with GTP (GPRS (General Packet Radio Service) Tunneling Protocol) on S2b
Instead of Step C.1 in FIG. 7.2.4-1 of 3GPP TS 23.402 V16.0.0,step 16c (Nudm_UECM_Registration with an optional indication that access is from ePDG) from FIG. 4.3.2.2.1-1 are performed between the SMF+PGW-C and HSS+UDM. Based on this indication, the HSS+UDM does not send notification of PGW-C assignment on SWx to AAA.

However, the above optional feature in 3GPP release 16 doesn't work in some scenario. For example, when UE triggers one or more PDN connection establishments in EPC over ePDG, the 3GPP AAA reads the user profile (including APN (Access Point Name) configuration and available SMF+PGW-C information) from HSS and caches the user profile locally.

As a first example, assuming PDN connection over Internet APN has been established over EPC/LTE, the cached information in AAA and in HSS/UDM may be as following:

### HSS/UDM:

APN: “Internet”, PGW address: “node1.pgw-s5s8.3gppnetwork.org”
APN: “IMS”, PGW address: “Null”

### AAA:

APN: “Internet”, PGW address: “node1.pgw-s5s8.3gppnetwork.org”
APN: “IMS”, PGW address: “Null”

When PDN connection (e.g. over IMS (IP Multimedia Subsystem) APN) is established, ePDG selects an SMF+PGW-C (e.g. node2.pgw-s5s8.3gppnetwork.org). The SMF+PGW-C updates HSS/UDM about its address information together with “ePDG access indication”. HSS/UDM would then not update the 3GPP AAA about the selected SMF+PGW-C address information based on the received “ePDG access indication”. Thereby the 3GPP AAA is keeping the old cached SMF+PGW-C information.

As a second example, the cached information in AAA and in HSS/UDM may be as following:

### HSS/UDM:

APN: “Internet”, PGW address: “node1.pgw-s5s8.3gppnetwork.org”
APN: “IMS”, PGW address: “node2.pgw-s5s8.3gppnetwork.org”, epdg-access-indication=true

### AAA:

APN: “Internet”, PGW address: “node1.pgw-s5s8.3gppnetwork.org”
APN: “IMS”, PGW address: “Null”

When UE performs handover of one of the PDN connections (e.g. IMS APN) to another 3GPP access, e.g. NG-RAN, E-UTRAN, the 3GPP AAA keeps the old user profile, e.g. in case there are multiple PDN connections setup over ePDG or the 3GPP AAA is configured to cache the user profile even without active PDN connections. 3GPP access reads from HSS/UDM of PGW assignment information and select the same node for handover, e.g. APN: “IMS”, PGW address: “node2.pgw-s5s 8.3gppnetwork.org”.

When the PDN connection is handed over back to EPC/ePDG again, the 3GPP AAA doesn't read user profile from HSS again, as there is local cache in the 3GPP AAA.

As a third example, the cached information in AAA and in HSS/UDM during handover between 3GPP access and Non-3GPP access may be as following:

### HSS/UDM:

APN: “Internet”, PGW address: “node1.pgw-s5s8.3gppnetwork.org”
APN: “IMS”, PGW address: “node2.pgw-s5s8.3gppnetwork.org”, epdg-access-indication=true

### AAA:

APN: “Internet”, PGW address: “node1.pgw-s5s8.3gppnetwork.org”
APN: “IMS”, PGW address: “Null”

In this case, the 3GPP AAA provides to ePDG the wrong SMF+PGW-C information (i.e. APN: “IMS”, PGW address: “Null”). Handover from 3GPP access to Non-3GPP access would then fail.

To overcome or mitigate the above mentioned problem or other problems, the embodiments of the present disclosure propose an improved information synchronization solution.

FIG. 4 shows a flowchart of a method according to an embodiment of the present disclosure, which may be performed by an apparatus implemented in a data management node or communicatively coupled to the data management node. As such, the apparatus may provide means or modules for accomplishing various parts of the method 400 as well as means or modules for accomplishing other processes in conjunction with other components. The data management node may be any suitable node which can implement data management function. For example, the data management node may be HSS+UDM for example as shown in FIGS. 1-3.

At block 402, the data management node may receive a first message including an identity of a first gateway from the first gateway. The first gateway may serve a session of a terminal device. The terminal device accesses to a network from a second gateway.

In an embodiment, the first gateway may be a combined session management function plus packet data network gateway control plane (SMF+PGW-C) entity for example as shown in FIGS. 1-3.

In an embodiment, the second gateway may be an evolved packet data gateway (ePDG) for example as shown in FIGS. 1-3.

In an embodiment, the first message may be an Nudm_UECM_Registration Request as described in clause 5.2.3.2 of 3GPP TS 23.502 V16.4.0.

In an embodiment, the identity of the first gateway may be a fully qualified domain name (FQDN) or an Internet protocol (IP) address.

In an embodiment, the first message may be sent over the N10 interface between SMF+PGW-C and HSS+UDM. For example, when ePDG is connected to SMF+PGW-C, S6b is not used and a UE creates and deletes a PDN connection via ePDG connected to SMF+PGW-C, the registration and de-registration of PDN GW may be performed on the N10 interface instead of the S6b interface.

In an embodiment, the first message further includes a first indication that the terminal device accesses to the network from the second gateway.

In an embodiment, the first message may be Nudm_UECM_Registration with an optional indication that access is from ePDG as described in clause 7.2.4 of 3GPP TS 23.502 V16.4.0.

At block 404, optionally, the data management node may store the identity of the first gateway. For example, the data management node such as UDM may store this information in UDR by Nudr_DM_Update.

At block 406, the data management node may send a second message including the identity of the first gateway to an authentication, authorization, and accounting (AAA) server.

In an embodiment, the AAA server may be 3GPP AAA server for example as shown in FIGS. 1-3.

In an embodiment, the second message may further include a second indication for indicating the AAA server to suppress a request such as re-authorization towards the second gateway. The second indication may be any suitable form such as a new value to the existing flag or a new parameter, e.g. “ePDG access indication”. The AAA server may use this indication to suppress a request such as re-authorization procedure towards ePDG to avoid mis-interpretation/mis-handling in ePDG.

In an embodiment, the second message may further include a second indication for indicating that the terminal device accesses to the network from the second gateway.

In an embodiment, HSS/UDM may update the 3GPP AAA server about the selected SMF+PGW-C address information when N10 interface is used by SMF+PGW-C.

In an embodiment, HSS/UDM shall include an indication (a new value to the existing flag /or a new parameter, e.g. “ePDG access indication”) in notification of PGW-C assignment to the 3GPP AAA server, to indicate to the 3GPP AAA server the reason for this update. The 3GPP AAA server uses this indication to suppress a request such as re-authorization procedure towards ePDG to avoid mis-interpretation/mis-handling in ePDG.

In an embodiment, HSS/UDM may update the 3GPP AAA server about the selected SMF+PGW-C address and include the reason for this update.

In an embodiment, the second message is a Push-Profile-Request message.

According to various embodiments, it can enable HSS/UDM to update the 3GPP AAA server about the selected SMF+PGW information to ensure the 3GPP AAA server can use this information for later Handover procedure between 3GPP access and Non-3GPP access.

According to various embodiments, a new indication may be introduced in Push-Profile-Request message over Swx so that HSS can indicate the 3GPP AAA server to suppress a request such as re-authorization towards ePDG.

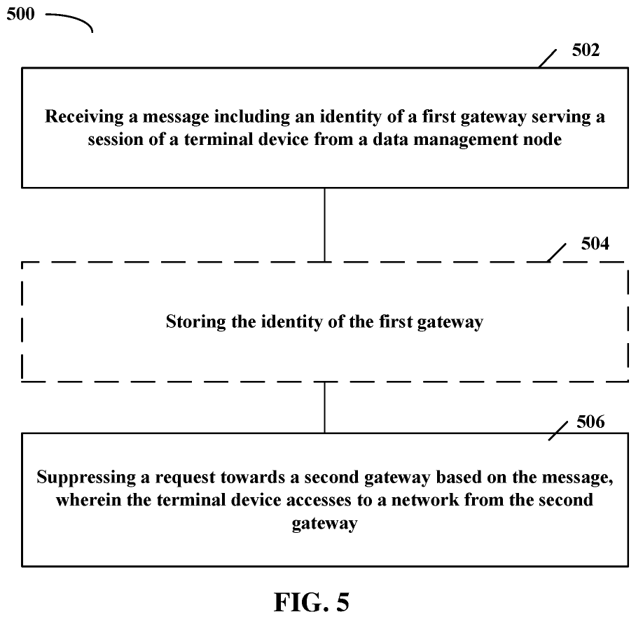

FIG. 5 shows a flowchart of a method according to another embodiment of the present disclosure, which may be performed by an apparatus implemented in an AAA server or communicatively coupled to the AAA server. As such, the apparatus may provide means or modules for accomplishing various parts of the method 500 as well as means or modules for accomplishing other processes in conjunction with other components. The AAA server may be any suitable node which can implement authentication, authorization, and accounting function. For example, the AAA server may be 3GPP AAA server for example as shown in FIGS. 1-3. For some parts which have been described in the above embodiments, the description thereof is omitted here for brevity.

At block 502, the AAA server may receive a message including an identity of a first gateway serving a session of a terminal device from a data management node. For example, the data management node may send the message including the identity of the first gateway to the AAA server at block 406 of FIG. 4, and then the AAA server may receive the message including the identity of the first gateway.

In an embodiment, the message may be a Push-Profile-Request message.

At block 504, optionally, the AAA server may store the identity of the first gateway. For example, the AAA server may store the identity of the first gateway in its local storage.

At block 506, the AAA server may suppress a request such as re-authorization towards a second gateway based on the message.

In an embodiment, the request may be a re-authorization request.

In an embodiment, the message further includes an indication for indicating the AAA server to suppress a request such as re-authorization towards the second gateway.

In an embodiment, the message further includes an indication for indicating that the terminal device accesses to the network from the second gateway.

In an embodiment, the identity of the first gateway is a fully qualified domain name (FQDN) or an Internet protocol (IP) address.

In an embodiment, the data management node is a combined home subscriber server plus unified data management (HSS+UDM) entity.

In an embodiment, the first gateway is a combined session management function plus packet data network gateway control plane (SMF+PGW-C) entity.

In an embodiment, the second gateway is an evolved packet data gateway (ePDG).

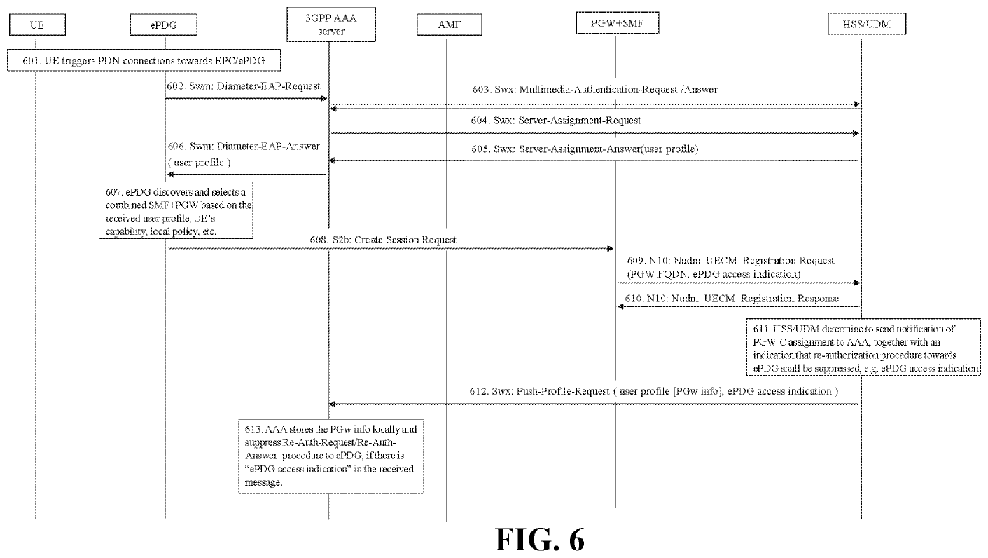

FIG. 6 shows a flowchart of a method according to another embodiment of the present disclosure.

At step 601, UE triggers PDN connection towards EPC/ePDG.

At step 602, ePDG may send a Diameter-EAP(Extensible Authentication Protocol)-Request over Swm interface to 3GPP AAA server.

At step 603, 3GPP AAA server may send Multimedia-Authentication-Request over Swx interface to HSS/UDM and receive Multimedia-Authentication-Answer over Swx interface from HSS/UDM.

At step 604, 3GPP AAA server may send Server-Assignment-Request over Swx interface to HSS/UDM.

At step 605, 3GPP AAA server may receive Server-Assignment-Answer (including user profile) over Swx interface from HSS/UDM.

At step 606, 3GPP AAA server may send a Diameter-EAP-Answer over Swm interface to ePDG.

At step 607, ePDG may discover and select a combined SMF+PGW based on the received user profile, UE's capability, local policy, etc.

At step 608, ePDG may send a Create Session Request over S2b to the selected SMF+PGW.

At step 609, SMF+PGW may send Nudm_UECM_Registration Request over N10 interface to HSS/UDM. The Nudm_UECM_Registration Request may include PGW information such as PGW FQDN and ePDG access indication. HSS/UDM may store the

PGW information such as PGW FQDN and/or ePDG access indication. For example the PGW information may be stored in a user profile.

At step 610, HSS/UDM may send Nudm_UECM_Registration Response over N10 interface to SMF+PGW.

In steps 601-610, UE triggers PDN connections towards EPC/ePDG, with N10 interface used by the selected SMF+PGW-C for PGW information reporting to HSS/UDM, as per clause 4.11.4.3.6 of 3GPP TS 23.502 V16.4.0.

At step 611, HSS/UDM may determine to send notification of PGW-C assignment to the 3GPP AAA server together with an indication that a request such as re-authorization procedure towards ePDG shall be suppressed, e.g., ePDG access indication.

For example, HSS/UDM updates the 3GPP AAA server about the selected SMF+PGW-C address information when N10 interface is used by SMF+PGW-C to register its address in HSS/UDM. If ePDG access indication is received in the previouse steps, HSS/UDM populate an indication to indicate 3GPP AAA server to suppress a request such as re-authorization procedure towards ePDG. For example, this indication can be ePDG access indication. Note that HSS/UDM may populate the same indication also in other scenarios.

At step 612, HSS/UDM may send Push-Profile-Request to 3GPP AAA server. The Push-Profile-Request may include PGW information as part of user profile and the indication such as ePDG access indication.

At step 613, 3GPP AAA server may store the PGW information locally and suppress Re-Authorization-Request/Re-Authorization-Answer procedure to ePDG if there is the indication such as ePDG access indication in the received message.

FIG. 7a illustrates a simplified block diagram of an apparatus 710 that may be embodied in/as a data management node according to an embodiment of the present disclosure. FIG. 7b illustrates a simplified block diagram of an apparatus 720 that may be embodied in/as an AAA server according to an embodiment of the present disclosure.

The apparatus 710 may comprise at least one processor 711, such as a data processor (DP) and at least one memory (MEM) 712 coupled to the processor 711. The apparatus 710 may further comprise a transmitter TX and receiver RX 713 coupled to the processor 711. The MEM 712 stores a program (PROG) 714. The PROG 714 may include instructions that, when executed on the associated processor 711, enable the apparatus 710 to operate in accordance with the embodiments of the present disclosure, for example to perform the methods related to the user plane function node. A combination of the at least one processor 711 and the at least one MEM 712 may form processing means 715 adapted to implement various embodiments of the present disclosure.

The apparatus 720 comprises at least one processor 721, such as a DP, and at least one MEM 722 coupled to the processor 721. The apparatus 720 may further comprise a transmitter TX and receiver RX 723 coupled to the processor 721. The MEM 722 stores a PROG 724. The PROG 724 may include instructions that, when executed on the associated processor 721, enable the apparatus 720 to operate in accordance with the embodiments of the present disclosure, for example to perform the methods related to the control plane function node. A combination of the at least one processor 721 and the at least one MEM 722 may form processing means 725 adapted to implement various embodiments of the present disclosure.

Various embodiments of the present disclosure may be implemented by computer program executable by one or more of the processors 711 and 721, software, firmware, hardware or in a combination thereof.

The MEMs 712 and 722 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 711 and 721 may be of any type suitable to the local technical environment, and may include one or more of general purpose computers, special purpose computers, microprocessors, digital signal processors DSPs and processors based on multicore processor architecture, as non-limiting examples.

In an embodiment where the apparatus is implemented as or at the data management node, the memory 721 contains instructions executable by the processor 721, whereby the data management node operates according to the method 400 as described in reference to FIG. 4.

In an embodiment where the apparatus is implemented as or at the AAA server, the memory 722 contains instructions executable by the processor 721, whereby the AAA server operates according to the method 500 as described in reference to FIG. 5.

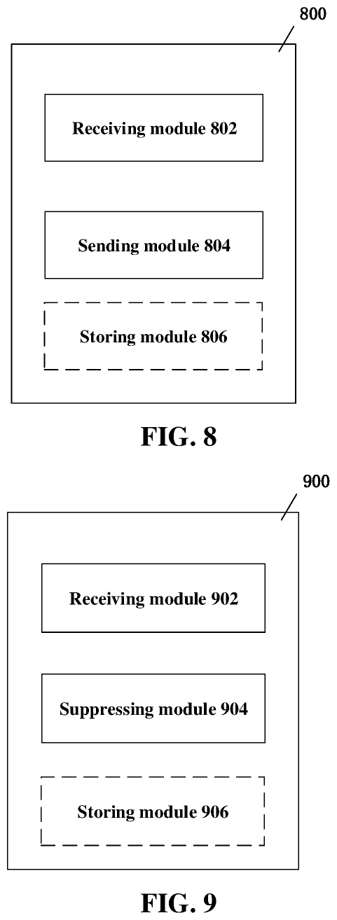

FIG. 8 is a block diagram showing a data management node according to an embodiment of the disclosure. As shown, the data management node 800 comprises a receiving module 802 and a sending module 804. The receiving module 802 may be configured to receive a first message including an identity of a first gateway from the first gateway. The first gateway serves a session of a terminal device. The terminal device accesses to a network from a second gateway. The sending module 804 may be configured to send a second message including the identity of the first gateway to an authentication, authorization, and accounting (AAA) server. The first message further includes a first indication that the terminal device accesses to the network from the second gateway

In an embodiment, the data management node 800 may further comprises a storing module 806 configured to store the identity of the first gateway.

FIG. 9 is a block diagram showing an AAA server according to an embodiment of the disclosure. As shown, the AAA server 900 comprises a receiving module 902 and a suppressing module 904. The receiving module 902 may be configured to receive a message including an identity of a first gateway serving a session of a terminal device from a data management node. The suppressing module 904 may be configured to suppress a request such as re-authorization towards a second gateway based on the message. The terminal device accesses to a network from the second gateway.

In an embodiment, the AAA server 900 may further comprises a storing module 906 configured to store the identity of the first gateway.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the data management node and/or the AAA server may not need a fixed processor or memory. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out the method related to the data management node as described above.

According to an aspect of the disclosure it is provided a computer program product being tangibly stored on a computer readable storage medium and including instructions which, when executed on at least one processor, cause the at least one processor to carry out the method related to the AAA server as described above.

According to an aspect of the disclosure it is provided a computer-readable storage medium storing instructions which when executed by at least one processor, cause the at least one processor to perform the method related to the data management node as described above.

According to an aspect of the disclosure it is provided a computer-readable storage medium storing instructions which when executed by at least one processor, cause the at least one processor to perform the method related to the AAA server as described above.

Embodiments herein afford many advantages, of which a non-exhaustive list of examples follows. In some embodiments herein, the proposed solution can ensure correct PGW assignment information available in 3GPP AAA server if PGW-C+SMF is selected for UEs establishing PDN connection from ePDG and N10 interface is used to report PGW assignment information to HSS/UDM. Therefore, in later handover, the 3GPP AAA server can provide the proper information of PGW to ePDG. In some embodiments herein, the proposed solution can ensure a proper indication is provided to the 3GPP AAA server hence it can suppress a request such as re-authorization procedure towards ePDG to avoid mis-interpretation/mis-handling in ePDG. The embodiments herein are not limited to the features and advantages mentioned above. A person skilled in the art will recognize additional features and advantages upon reading the following detailed description.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method at a data management node, comprising:
receiving a first message including an identity of a first gateway from the first gateway, wherein the first gateway serves a session of a terminal device and the terminal device accesses to a network from a second gateway; and
sending a second message including the identity of the first gateway to an authentication, authorization, and accounting (AAA) server,
wherein the first message further includes a first indication that the terminal device accesses to the network from the second gateway.

2. The method according to claim 1, wherein the second message further includes a second indication for indicating the AAA server to suppress a request towards the second gateway.

3. The method according to claim 2, wherein the request is a re-authorization request.

4. The method according to claim 1, wherein the second message further includes a second indication for indicating that the terminal device accesses to the network from the second gateway.

5. The method according to any of claim 1, further comprising:
storing the identity of the first gateway.

6. The method according to any of claim 1, wherein the identity of the first gateway is a fully qualified domain name (FQDN) or an Internet protocol (IP) address.

7. The method according to any of claim 1, wherein the data management node is a combined home subscriber server plus unified data management (HSS+UDM) entity.

8. The method according to any of claim 1, wherein the first gateway is a combined session management function plus packet data network gateway control plane (SMF+PGW-C) entity.

9. The method according to any of claim 1, wherein the second gateway is an evolved packet data gateway (ePDG).

10. The method according to any of claim 1, wherein the first message is an Nudm_UECM_Registration Request.

11. The method according to any of claim 1, wherein the second message is a Push-Profile-Request message.

12. A method at an authentication, authorization, and accounting (AAA) server, comprising:
receiving a message including an identity of a first gateway serving a session of a terminal device from a data management node; and
suppressing a request towards a second gateway based on the message,
wherein the terminal device accesses to a network from the second gateway.

13. The method according to claim 12, wherein the request is a re-authorization request.

14. The method according to claim 12, wherein the message further includes an indication for indicating the AAA server to suppress the request towards the second gateway.

15. The method according to claim 12, wherein the message further includes an indication for indicating that the terminal device accesses to the network from the second gateway.

16. The method according to claim 12, wherein the message is a Push-Profile-Request message.

17. The method according to claim 12, further comprising:
storing the identity of the first gateway.

18. The method according to claim 12, wherein the identity of the first gateway is a fully qualified domain name (FQDN) or an Internet protocol (IP) address.

19. The method according to claim 12, wherein the data management node is a combined home subscriber server plus unified data management (HSS+UDM) entity;
wherein the first gateway is a combined session management function plus packet data network gateway control plane (SMF+PGW-C) entity; and
wherein the second gateway is an evolved packet data gateway (ePDG).

20. (canceled)

21. (canceled)

22. A data management node, comprising:
a processor; and
a memory coupled to the processor, said memory containing instructions executable by said processor, whereby said data management node is operative to:
receive a first message including an identity of a first gateway from the first gateway, wherein the first gateway serves a session of a terminal device and the terminal device accesses to a network from a second gateway; and
send a second message including the identity of the first gateway to an authentication, authorization, and accounting (AAA) server,
wherein the first message further includes a first indication that the terminal device accesses to the network from the second gateway.

23.-27. (canceled)
